(19) United States
(12) Patent Application Publication
(10) Pub. No.: US 2026/0109462 A1
(43) Pub. Date: Apr. 23, 2026

(54) RADIANT HEATING DEVICE FOR AN AIRCRAFT AND CABIN ELEMENT COMPRISING SUCH A DEVICE

(71) Applicant: Safran Seats, Plaisir (FR)

(72) Inventor: Arnaud Faivre, Moissy-Cramayel (FR)

(21) Appl. No.: 19/117,615

(22) PCT Filed: Sep. 28, 2023
(86) PCT No.: PCT/FR2023/051496

§ 371 Date: Apr. 1, 2025

(30) Foreign Application Priority Data
Oct. 5, 2022 (FR) 2210187

(51) Int. Cl. B64D 11/06; H05B 3/02; H05B 3/26

(52) U.S. Cl. CPC B64D 11/0626; H05B 3/02; H05B 3/267; H05B 2203/019

(57) ABSTRACT

This radiant heating device for an aircraft comprises a heating layer provided with at least one anode and at least one cathode a front protective layer and a rear protective layer disposed on either side of the heating layer, a shell secured to the front protective layer, and at least one temperature sensor configured to provide temperature information on the heating device to an external control unit, the temperature sensor comprising a thermistor of the negative temperature coefficient type disposed on the rear protective layer opposite the front protective layer.

### TECHNICAL FIELD

The present invention relates to a heating device for the thermal comfort of a passenger in an aircraft cabin and a cabin element comprising such a device.

### PRIOR ART

A radiant electric heating device diffuses heat by radiation. Such a device generally comprises a heating layer and a layer of electrodes interposed between two insulating layers.

To be integrated in an aircraft, the heating device must obtain a navigability certificate in order to guarantee the safety of passengers by complying in particular with the strict fire-resistance constraints.

To guarantee the comfort of the passengers in the aircraft and to enable the passengers to touch the heating device without risk of burns, the temperature of the heating device must be controlled.

### DESCRIPTION OF THE INVENTION

In the light of the above, the objective of the present invention is to propose a particularly fire-resistant heating device.

The object of the present invention is a radiant heating device for an aircraft comprising a heating layer provided with at least one anode and at least one cathode, a front protective layer and a rear protective layer disposed on either side of the heating layer, and a shell secured to the front protective layer, the device comprising at least one temperature sensor configured to provide temperature information on the heating device to an external control unit.

The temperature sensor transmits the temperature information to the external control unit, which can then guarantee the comfort and safety of the passengers in the aircraft.

Advantageously, the temperature sensor comprises a thermistor of the negative temperature coefficient type disposed on the rear protective layer opposite the front protective layer.

Optionally, the shell comprises at least one fire-resistant thermoplastic material, the thermoplastic material preferably comprising acrylic and polyvinyl chloride.

Advantageously, the device comprises a first fire-resistant securing means disposed between the front protective layer and the shell.

Optionally, the first securing means comprises a first dual-face adhesive strip, the first dual-face adhesive strip preferably comprising fabric and vulcanised rubber.

Advantageously, the device comprises a second fire-resistant securing means disposed between the rear protective layer and the heating layer.

In one embodiment, the second securing means comprises a second dual-face adhesive strip, the second dual-face adhesive strip preferably comprising polyethylene terephthalate and acrylic.

The front protective layer can comprise polyimide and a copper cladding.

Optionally, the device comprises an intermediate protective layer disposed between the heating layer and the second securing means.

Advantageously, the device comprises a radiant-heat insulation layer disposed between the rear protective layer and the second securing means.

Another object of the invention is an aircraft cabin element comprising a control unit and at least one heating device as defined above, the temperature sensor providing the temperature information on the heating device to the control unit.

### BRIEF DESCRIPTION OF THE DRAWINGS

Other aims, features and advantages of the invention will become apparent upon reading the following description, given merely as a non-limiting example, and made with reference to the appended drawing:

FIG. 1 illustrates schematically a radiant heating device according to the invention communicating with the control unit; and FIG. 2 illustrates schematically an aircraft cabin element according to the invention.

### DETAILED DESCRIPTION

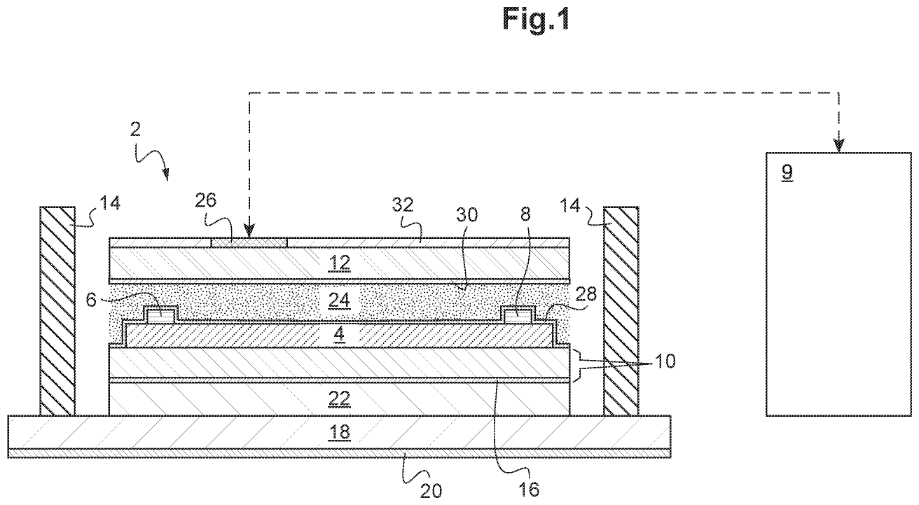

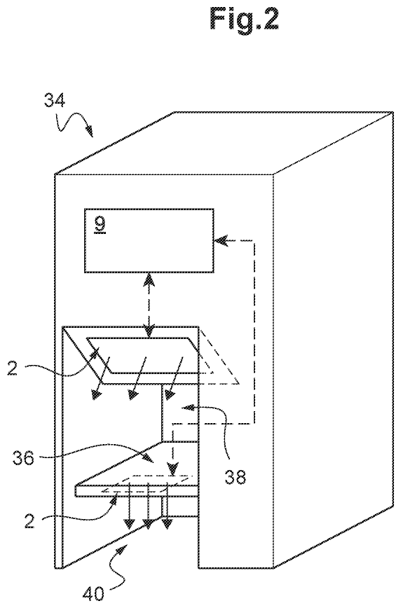

FIG. 1 shows schematically a radiant heating device 2 intended to equip interior equipment of a cabin of an aircraft, for example an aeroplane or helicopter, the heating device 2 comprising a plurality of layers stacked so as to form a multilayer structure.

The heating device 2 comprises a heating layer 4 provided with at least one anode 6 and at least one cathode 8 both intended to provide the interface with electrical connections, the anode 6 and cathode 8 being elements associated with the heating layer 4 but distinct from the heating layer 4, the anode 6 and the cathode 8 comprising for example a metal ink, for example a silver ink.

The electrical connections are for example made by electric wires and connectors (not shown) so as to electrically connect the anode 6 and the cathode 8 to an external control unit 9 of the aircraft, the control unit 9 being able to generate an electric current intended to travel through the heating layer 4 so that the heating layer 4 emits radiant heat.

The heating layer 4 is able to limit the temperature of the radiant heat below a threshold value, in particular by increasing the electrical resistance of the heating layer 4. For this purpose, the heating element 4 comprises for example a material of the positive temperature coefficient type or a material having a high thermal-resistance coefficient, for example a carbon ink or a mixture of metals comprising copper.

In one embodiment, the heating layer 4 comprises a plurality of materials in order to increase the flexibility of the heating layer 4 and/or to allow various levels of heat along the heating layer 4.

The heating device 2 comprises a front protective layer 10 and a rear protective layer 12 disposed on either side of the heating layer 4. Front means the side of the heating device 2 intended to be oriented towards a passenger in the aircraft. Rear means the side of the heating device 2 intended to be oriented towards a support of the aircraft (not shown), the heating device 2 comprising for example two securing elements 14 for securing the heating device 2 to the support. The securing elements 14 comprise for example removable securing clips and/or self-gripping fasteners and/or screws. The front and rear protective layers 10, 12 provide the mechanical strength and the electrical and environmental protection of the heating device 2, the environmental protection corresponding for example to a protection against humidity or against the temperature external to the heating device 2 or chemical protection.

The front protective layer 10 comprises for example polyimide and a copper cladding 16. For example, the thickness of the polyamide is between 12 and 45 μm and the thickness of the copper cladding 16 is between 9 and 35 μm. In one embodiment, the protective layer comprises a material marketed under the DuPont tradename Pyralux AC®.

The rear protective layer 12 comprises for example polyimide.

The heating device 2 comprises a shell 18 made from plastics material secured to the front protective layer 10. The plastic shell 18 is liable to be in contact with a passenger. The plastic shell 18 comprises at least one fire-resistant thermoplastic material to protect the passenger. Furthermore, the thermoplastic material has high thermal conductivity to facilitate the transfer of heat from the heating layer 4 to the passenger and thermal inertia enabling the plastic shell 18 to reach a comfort temperature, the comfort temperature being sufficiently high to ensure the comfort of the passenger and sufficiently low to be touched by the passenger without risk of burns.

The thermoplastic material is a fire-resistant material, having for example received frame-retardant treatments. The thermoplastic material comprises for example acrylic and polyvinyl chloride, in particular so that the plastic shell 18 has a burn length of less than 5 mm and a mean flame time of less than 1 second during a vertical burn test of twelve seconds, “vertical burn 12 s”. In one embodiment, the thermoplastic material comprises the commercial material Kydex 5555®.

Optionally, the heating device 2 comprises a decorative layer 20 secured to the plastic shell 18 and intended to be visible to the passengers in the aircraft, the decorative layer 20 having the same properties as the plastic shell 18, in particular with regard to fire resistance.

Preferably, the plastic shell 18 is secured to the front protective layer 10 by means of a first fire-resistant securing means 22, the first securing means 22 having for example received frame-retardant treatments.

The first securing means 22 comprises for example a first dual-face adhesive strip. In one embodiment, the first dual-face adhesive strip comprises fabric covered on either side with vulcanised rubber, the thickness of the first adhesive strip being for example between 310 and 350 μm. In one embodiment, the first dual-face adhesive strip comprises the commercial material Nitto P55®.

Preferably, the heating layer 4 is secured to the rear protective layer 12 by means of a second fire-resistant securing means 24, the second securing means 24 having for example received frame-retardant treatments.

The second securing means 24 comprises for example a second dual-face adhesive strip. In one embodiment, the second dual-face adhesive strip comprises polyethylene terephthalate covered on either side with acrylic, the thickness of the second adhesive strip being for example between 45 and 55 μm. In one embodiment, the second dual-face adhesive strip comprises the commercial material Tesa 58372®.

The heating device 2 comprises at least one temperature sensor 26 able to supply temperature information on the heating device 2 to the control unit 9, in particular temperature information on the heating layer 4.

The heating device 2 comprises a thermistor of the negative temperature coefficient type disposed on the rear protective layer 12 opposite to the front protective layer 10 and electronically connected to the external control unit 9, the external control unit 9 being able to control the temperature of the heating device 2 according to the temperature information.

Optionally, the heating device 2 comprises an intermediate protective layer 28 disposed between the heating layer 4 and the rear protective layer 12, for example disposed between the heating layer 4 and the second securing means 24. The intermediate protective layer 28 comprising for example a solvent protecting the heating layer 4 from mechanical attacks.

The heating device 2 can comprise a thermally insulating layer 30 providing thermal protection against radiant heat. This thermally insulating layer 30 is disposed between the heating layer 4 and the rear protective layer 12, for example disposed between the rear protective layer 12 and the second securing means 24. The thermally insulating layer 30 comprising for example a metal material so as to reflect the radiant heat emitted by the heating layer 4 and directed towards the rear protective layer 12 in order to be oriented towards the passenger. The thermally insulating layer 30 also increases the robustness to fire of the heating device 2.

The heating device 2 can also comprise a dorsal protective layer 32 disposed on the rear protective layer 12 opposite to the front protective layer 10. The dorsal protective layer 32 comprises for example an insulating foam able to limit the amount of radiant heat escaping from the heating device 2 through the rear protective layer 12, in particular so as to increase the radiant heat in the direction of the front protective layer 10 and therefore in the direction of the passenger.

FIG. 2 shows schematically a cabin element 34 of the aircraft comprising a control unit 9 and two heating devices 2. The control unit 9 is able to control the temperature of the two heating devices 2, in particular by the use of the temperature information on the two heating devices 2.

The cabin element 34 is for example a seat of the aircraft provided with a leg rest panel 36, a recess for the legs 38 and a housing for the feet 40. A passenger in the aircraft can extend their legs in the recess 38 for the legs so as to rest their legs on the leg rest panel 36 or insert their feet in the housing 40 for the feet. The two heating devices 2 are able to heat the legs and/or feet of the passenger according to the position of the passenger.

In another embodiment, the cabin element 34 comprises a wall of the aircraft close to the passenger, for example the cabin element 34 comprises the false floor of the cabin of the aircraft, the heating device 2 being disposed on the wall so as to heat the passenger.

1. Radiant heating device for an aircraft comprising a heating layer provided with at least one anode and at least one cathode, a front protective layer and a rear protective layer disposed on either side of the heating layer, a shell secured to the front protective layer, and at least one temperature sensor configured to provide temperature information on the heating device to an external control unit, the temperature sensor comprising a thermistor of the negative temperature coefficient type disposed on the rear protective layer opposite the front protective layer.

2. Device according to claim 1, wherein the shell comprises at least one fire-resistant thermoplastic material.

3. Device according to claim 1, comprising a first fire-resistant securing means disposed between the front protective layer and the shell.

4. Device according to claim 3, wherein the first securing means comprises a first dual-face adhesive strip.

5. Device according to claim 1, comprising a second fire-resistant securing means disposed between the front protective layer and the heating layer.

6. Device according to claim 5, wherein the second securing means comprises a second dual-face adhesive strip.

7. Device according to claim 1, wherein the front protective layer comprises polyimide and a copper cladding.

8. Device according to claim 5, comprising an intermediate protective layer disposed between the heating layer and the second securing means.

9. Device according to claim 5, comprising a radiant-heat insulation layer disposed between the rear protective layer and the second securing means.

10. Aircraft cabin element comprising a control unit and at least one heating device according to claim 1, the temperature sensor providing the temperature information on the heating device to the control unit.
